(19) United States
(12) Patent Application Publication
(10) Pub. No.: US 2025/0330275 A1
(43) Pub. Date: Oct. 23, 2025

(54) HARQ PROCESS ALLOCATION METHOD, BASE STATION, AND STORAGE MEDIUM

(71) Applicant: REALME CHONGQING MOBILE TELECOMMUNICATIONS CORP. LTD., Chongqing (CN)

(72) Inventor: Yuchun LUO, Chongqing (CN)

(73) Assignee: REALME CHONGQING MOBILE TELECOMMUNICATIONS CORP. LTD., Chongqing (CN)

(21) Appl. No.: 19/180,340

(22) Filed: Apr. 16, 2025

Related U.S. Application Data
(63) Continuation of application No. PCT/CN2023/114756, filed on Aug. 24, 2023.

(30) Foreign Application Priority Data
Oct. 18, 2022 (CN) 202211275488.X

(51) Int. Cl. H04L 1/1822; H04W 52/02

(52) U.S. Cl. CPC H04L 1/1822; H04W 52/0212

(57) ABSTRACT

The present application provides a HARQ process allocation method and apparatus, a base station and a storage medium. The HARQ process allocation method may include: receiving first information reported by user equipment, the first information being configured to indicate whether the user equipment needs to enter an energy-saving mode, operation modes of the user equipment including the energy-saving mode and a normal mode, and the power consumption in the energy-saving mode of the user equipment being lower than that in the normal mode of the user equipment; according to the first information, determining a first target number of HARQ processes configured for the user equipment; and issuing to the user equipment the first target number.

### CROSS REFERENCE TO RELATED APPLICATIONS

This application is a continuation of International Patent Application No. PCT/CN2023/114756, filed Aug. 24, 2023, which claims priority to Chinese Patent Application No. 202211275488.X, filed Oct. 18, 2022, and entitled “HARQ process allocation method, HARQ process allocation apparatus, base station, and storage medium”, both of which are herein incorporated by reference in their entireties.

### TECHNICAL FIELD

The present disclosure relates to the field of communication technologies, and in particular to a HARQ process allocation method, a HARQ process allocation apparatus, a base station, and a storage medium.

### BACKGROUND

In the related art, a base station may usually configure, for the user equipment, the maximum number of HARQ processes supported by the user equipment. The user equipment may often need to continuously perform blind detection of the physical downlink common control channel (PDCCH) and synchronously cache the physical downlink shared channel (PDSCH) data of the entire bandwidth part (BWP) within the time slot. As a result, power consumption of the user equipment may usually be wasted seriously.

### SUMMARY

According to a first aspect of the present disclosure, a hybrid automatic repeat request (HARQ) process allocation method may be provided. The method may include: receiving first information reported by user equipment, wherein the first information may be configured to indicate whether the user equipment needs to enter an energy-saving mode, operation modes of the user equipment may include the energy-saving mode and a normal mode, a power consumption of the user equipment in the energy-saving mode may be less than that of the user equipment in the normal mode: determining, according to the first information, a first target number of the HARQ processes configured for the user equipment: and issuing the first target number to the user equipment.

According to a second aspect of the present disclosure, a base station may be provided. The base station may include a memory and a processor. The memory may store an executable program code. The processor may be coupled to the memory. The processor may be configured to call the executable program code stored in the memory: The executable program code, when being executed by the processor, may enable the processor to implement a HARQ process allocation method. The method may include: receiving first information reported by user equipment, wherein the first information may be configured to indicate whether the user equipment needs to enter an energy-saving mode, operation modes of the user equipment may include the energy-saving mode and a normal mode, a power consumption of the user equipment in the energy-saving mode may be less than that of the user equipment in the normal mode: determining, according to the first information, a first target number of the HARQ processes configured for the user equipment: and issuing the first target number to the user equipment.

According to a third aspect of the present disclosure, a non-transitory computer-readable storage medium may be provided. An executable program code may be stored on the computer-readable storage medium. The executable program code, when being executed by a processor, may implement a HARQ process allocation method. The method may include: receiving first information reported by user equipment, wherein the first information may be configured to indicate whether the user equipment needs to enter an energy-saving mode, operation modes of the user equipment may include the energy-saving mode and a normal mode, a power consumption of the user equipment in the energy-saving mode may be less than that of the user equipment in the normal mode: determining, according to the first information, a first target number of the HARQ processes configured for the user equipment: and issuing the first target number to the user equipment.

### BRIEF DESCRIPTION OF THE DRAWINGS

In order to more clearly illustrate technical solutions of embodiments of the present disclosure, the drawings required in the description of the embodiments and the related art will be briefly introduced below. Obviously; the drawings in the following description may be only some embodiments of the present disclosure. Other drawings may be further obtained based on these drawings.

FIG. 1 is a schematic diagram of an embodiment of an application scenario according to the present disclosure.

FIG. 2 is a schematic flowchart of an embodiment of a HARQ process allocation method according to the present disclosure.

FIG. 3 is a schematic flowchart of another embodiment of a HARQ process allocation method according to the present disclosure.

FIG. 4 is a structural schematic diagram of an embodiment of a HARQ process allocation apparatus according to the present disclosure.

FIG. 5 is a structural schematic diagram of an embodiment of a base station according to the present disclosure.

### DETAILED DESCRIPTION

Embodiments of the present disclosure may provide a HARQ process allocation method, a HARQ process allocation apparatus, a base station, and a storage medium, which may reduce power consumption waste of user equipment.

In order to enable those of ordinary skills in the art to better understand the technical solutions of the present disclosure, the technical solutions in embodiments of the present disclosure will be described in connection with accompanying drawings of the embodiments of the present disclosure. Obviously, the described embodiments may be merely a part of the embodiments but not all of them. All embodiments based on the present disclosure may fall within the protection scope of the present disclosure.

The proper nouns involved in embodiments of the present disclosure may be explained below.

Hybrid automatic repeat request (HARQ): may be a retransmission mechanism at a media access control (MAC) layer and may use the stop-and-wait protocol to send data. The stop-and-wait protocol may mean that, after sending a transmission block, stopping and waiting for confirmation information.

Downlink control information (DCI): may be information sent by the base station to user equipment, which may include downlink scheduling information, uplink scheduling information or other control information.

Radio network temporary identifier (RNTI): may be information configured to identify different user equipment.

Physical downlink common control channel (PDCCH): may mainly undertake an interactive transmission of physical layer control messages and may be an important means for efficient interaction and control information between the base station and the user equipment.

Physical downlink shared channel (PDSCH): may be a downlink channel for carrying data and may be configured to carry downlink data for all users as well as to carry system broadcast information and paging information that is not transmitted in the physical broadcast channel (PBCH).

Bandwidth part (BWP): may refer to a combination of a plurality of consecutive resource blocks (RB) within a carrier.

The technical solutions of the embodiments of the present disclosure may be applied to various communication systems, such as: the global system for mobile communications (GSM), the code division multiple access (CDMA), the wideband code division multiple access wireless (WCDMA) system, the general packet radio service (GPRS), the long-term evolution (LTE) system, the new radio (NR) system, or the like.

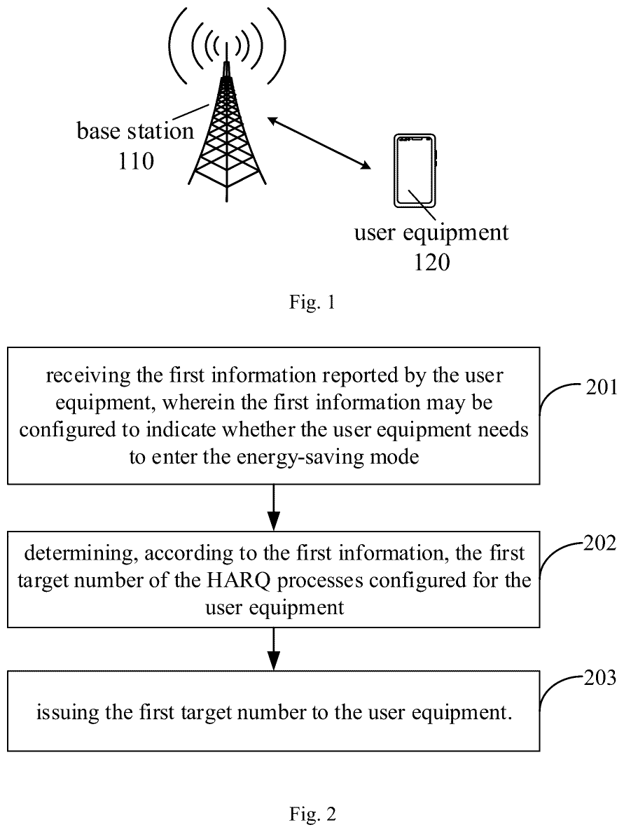

FIG. 1 is a schematic diagram of an embodiment of an application scenario according to the present disclosure. As illustrated in FIG. 1, the application scenario may include a base station 110 and user equipment 120.

The base station 110 may be a base transceiver station (BTS) in the GSM or the CDMA, a NodeB in the WCDMA, an evolutional NodeB (eNB or e-NodeB) in the LTE, a next generation NodeB (gNB) in the NR system, a base station in the future mobile communication system, or an access point in the wireless fidelity (Wi-Fi) system. The base station 110 may also be a module or a unit that implements part of the functions of a base station, such as a central unit (CU) or a distributed unit (DU). The specific technology and the specific device configuration employed by the base station 110 may not be limited in embodiments of the present disclosure.

The user equipment 120, also known as a mobile terminal, a mobile user equipment, etc., may communicate with one or more core networks through a radio access network (e.g., RAN). The user equipment may be a mobile terminal, such as a mobile phone (or be referred to as a “cellular” phone) or a computer with a mobile terminal. For example, the user equipment 120 may be a portable, pocket-sized, handheld, computer built-in or vehicle-mounted mobile device that may exchange language and/or data with the radio access network.

The case illustrated in FIG. 1, where the number of the base station is I and the number of the user equipment is 1, may only be one example. In actual processes, the number of the base stations and the number of the user equipment may also be other values. Of course, this scenario may further include other network elements. For example, this scenario may also include a core network device. The base station may be connected to this core network device. Specific forms of the base station and the user equipment may not be limited in embodiments of the present disclosure.

In a communication system, in order to obtain a reasonable configuration, the user equipment 120 may usually report its demand information (including a power consumption demand) to the base station. The base station 110, when receives demand information reported by the user equipment 120, may give the user equipment 120 a configuration that may match the demand information. A sending form of the demand information may be in the form of a radio resource control (RRC) layer message, or a media access control (MAC) layer message, which is not limited in embodiments of the present disclosure. When the sending form of the demand information uses the MAC layer message, the MAC layer message may be a MAC control clement (MAC CE), or may be a reserved bit in the MAC protocol data unit (PDU) header.

In the related art, the demand information reported by the user equipment 120 may include auxiliary information of the user equipment 120. The auxiliary information may include an expected value of the user equipment 120 for a network configuration parameter. The network configuration parameter may include the at least one selected from the group consisting of: a discontinuous reception (DRX) parameter, a maximum aggregated bandwidth, a maximum number of carrier waves, a maximum number of multiple-input multiple-output (MIMO) layers, a minimum scheduling offset value for cross-slot scheduling, and the RRC status. The base station 110, when receives the above-mentioned auxiliary information, may set the corresponding network configuration parameter according to the above-mentioned auxiliary information, and may configure, for the user equipment 120, the maximum number of HARQ processes that the user equipment 120 may support.

In each HARQ process, the user equipment 120 may usually need to perform a blind detection of PDCCH, and synchronously cache the PDSCH data of the entire BWP within a time slot. It may be seen that, when the base station 110 configures, for user equipment 120, the maximum number of HARQ processes that the user equipment 120 may support, the user equipment 120 may often need to continuously perform blind detection of PDCCH and synchronously cache the PDSCH data of the entire BWP within the time slot. In practice, it may be found that, if the user equipment 120 is in an energy-saving mode during usage, the base station 110 may usually provide less scheduling information to the user equipment 120. At this point, the user equipment 120 may perform a plurality of invalid blind detections of PDCCH (or invalid PDCCH blind detection) and cache a plurality of invalid PDSCH data. The power consumption waste of the user equipment 120 may be relatively serious.

Blind detection of PDCCH: the user equipment generally does not know what format of information is transmitted by the current DCI, nor does the user equipment know where the required information is located. But the user equipment may know what information is currently expected. For example, in an Idle state, the information expected by the user equipment may be paging and/or SI: after random access is initiated, the user equipment may expect RACH Response: when there is uplink data waiting to be sent, the user equipment may expect UL Grant, or the like. For different expected information, the user equipment may use corresponding RNTI and common search space (CCE) information to perform cyclic redundancy check (CRC) verification. If the CRC verification is successful, then the user equipment may know that this information is what it needs, and may also know the corresponding DCI format and modulation manner, so as to further decode the DCI content.

To solve the above-mentioned technical problem, in the present technical solution, the demand information reported by the user equipment 120 to the base station 110 may include first information. The first information may be configured to indicate whether the user equipment 120 needs to enter the energy-saving mode. The operation modes of the user equipment 120 may include the energy-saving mode and a normal mode. The power consumption of the user equipment 120 in the energy-saving mode may be less than that of the user equipment 120 in the normal mode. The base station 110 may identify, according to the first information reported by the user equipment 120, whether the user equipment 120 needs to enter the energy-saving mode, and may thus configure a corresponding number of HARQ processes for the user equipment 120 according to the identification result. In this way, a flexibility of the HARQ process allocation may be enhanced. In other words, for the user equipment 120 that needs to enter the energy-saving mode, a smaller number of HARQ processes may be allocated, and for the user equipment 120 that needs to enter the normal mode, a larger number of HARQ processes may be allocated. The number of the blind detections of PDCCH by the user equipment 120 may be effectively reduced, and caching of the invalid PDSCH data may be reduced, thereby effectively reducing the power consumption waste of the user equipment 120.

As illustrated in FIG. 2, FIG. 2 is a schematic flowchart of an embodiment of a HARQ process allocation method according to the present disclosure. The HARQ process allocation method or the allocation method of the HARQ processes may include the following operations at blocks as illustrated in FIG. 2.

The operation at block 201: receiving the first information reported by the user equipment. wherein the first information may be configured to indicate whether the user equipment needs to enter the energy-saving mode.

The operation modes of the user equipment may include the energy-saving mode and the normal mode. The power consumption of the user equipment in the energy-saving mode may be less than that of the user equipment 120 in the normal mode.

In some embodiments, before the operation at block 201, the base station may send indication information to the user equipment through an RRC message. The indication information may be configured to indicate that the user equipment sends the first information. When the user equipment receives the indication information, it may report the first information to the base station.

In some embodiments, the existing RRC message format may be extended to carry the above-mentioned indication information. In some embodiments, the above-mentioned indication information may also be a name of the RRC message. For example, a particular RRC message name may be pre-agreed to indicate that the user equipment has sent the first information. When the user equipment receives a particular RRC message name, it may report the first information to the base station. The indication information may also be a newly defined RRC message.

In some embodiments, the user equipment may actively report the first information. The user equipment may automatically report the first information only when necessary, and may not require the base station to send the indication information. According to difference of the triggering events, the autonomous report by the user equipment may be further divided into a periodic report and an event-triggered report.

In some embodiments, the first information may include the identification information and/or the auxiliary information of the user equipment. The identification information may be configured to indicate whether the user equipment needs to enter the energy-saving mode, which is not limited in embodiments of the present disclosure. The identification information may include at least one selected from the group consisting of: numbers, letters, and special characters.

The operation at block 202: determining, according to the first information, a first target number of the HARQ processes configured for the user equipment.

In some embodiments, the determining, according to the first information, the first target number of the HARQ processes configured for the user equipment may include: in a case where the first information indicates that the user equipment does not need to enter the energy-saving mode, determining the first target number as a first value: in a case where the first information indicates that the user equipment needs to enter the energy-saving mode, determining the first target number as a second value. The second value may be less than the first value.

In some embodiments of the present disclosure, the first target number may refer to the number of the uplink scheduling HARQ processes of the user equipment and/or the number of the downlink scheduling HARQ processes of the user equipment.

In a case where the first target number refers to the number of the uplink scheduling HARQ processes of the user equipment, the base station may configure a default number of downlink scheduling HARQ processes for the user equipment. In a case where the first target number refers to the number of downlink scheduling HARQ processes of the user equipment, the base station may configure the default number of uplink scheduling HARQ processes for the user equipment. As an example, the default number may be 16.

In some embodiments, the second value may be obtained by dividing the first value by 2. As an example, the first target number may refer to the number of the uplink scheduling HARQ processes of the user equipment. The first value may be 16. The second value may be 8.

The operation at block 203: issuing the first target number to the user equipment.

In some embodiments, the first target number may be issued to the user equipment through a dedicated signaling or a particular system message, which is not limited in embodiments of the present disclosure. The dedicated signaling may include any one selected from the group consisting of a high-level signaling, a layer one signaling, and a layer two signaling. As an example, the high-level signaling may include the RRC signaling. The layer one signaling and/or the layer two signaling may include a DCI signaling.

In some embodiments, the issuing the first target number to the user equipment may include: issuing, by the base station, the first target number to the user equipment through the RRC signaling, receiving response information fed back by the user equipment, and determining whether the first target number is successfully sent by analyzing the response information.

In a case where the response information indicates that the base station has successfully sent the first target number to the user equipment, the base station may perform data transmission with the user equipment according to the HARQ processes corresponding to or matching the first target number.

In some embodiments, in a case where the response information indicates that the base station has not successfully sent the first target number to the user equipment, the base station may issue the first target number to the user equipment again through the RRC signaling.

Particular system messages may be added system messages for notification. These system messages may be targeted at a certain type of user equipment. This user equipment that is not of this type may not be able to receive or parse these system messages.

By implementing the above-mentioned method, the base station may identify whether the user equipment needs to enter the energy-saving mode according to the first information reported by the user equipment, and may configure the corresponding number of HARQ processes for the user equipment according to the identification result. In this way: the flexibility of HARQ process allocation may be enhanced, and the power consumption waste of the user equipment may further be effectively reduced.

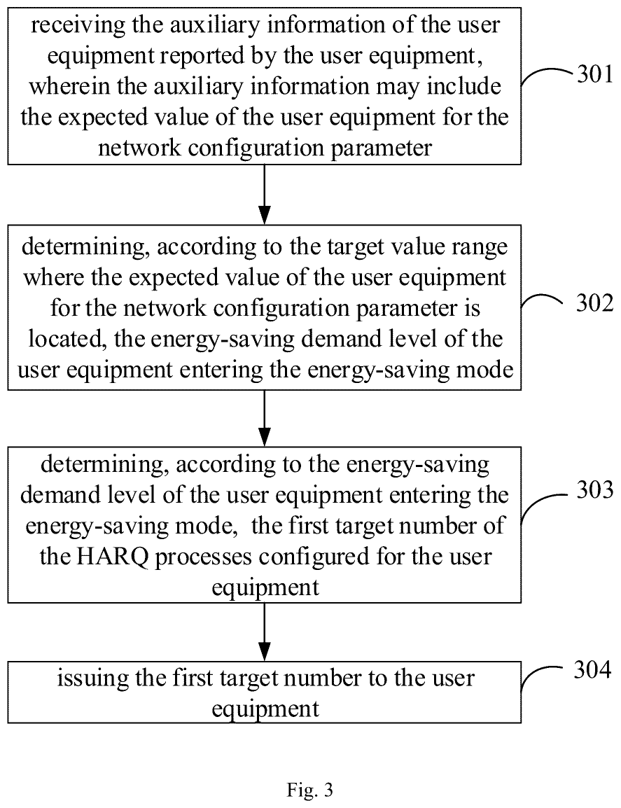

As illustrated in FIG. 3, FIG. 3 is a schematic flowchart of another embodiment of the HARQ process allocation method according to the present disclosure. The HARQ process allocation method may include the following operations at blocks as illustrated in FIG. 3.

The operation at block 301: receiving the auxiliary information of the user equipment reported by the user equipment. The auxiliary information may include the expected value of the user equipment for the network configuration parameter.

For the specific content of the sending manner of the auxiliary information and the network configuration parameters, please refer to the above-mentioned contents, which will not be elaborated herein.

The operation at block 302: determining, according to a target value range where the expected value of the user equipment for the network configuration parameter is located, an energy-saving demand level of the user equipment entering the energy-saving mode.

Each network configuration parameter may correspond to or match with a plurality of value ranges. For any network configuration parameter, different value ranges may correspond to or match with different energy-saving demand levels, respectively. The target value range where the expected value of the user equipment for the network configuration parameter is located may refer to the value range where the expected value of the user equipment for the network configuration parameter is located.

In some embodiments, the determining, according to the target value range where the expected value of the user equipment for the network configuration parameter is located, the energy-saving demand level of the user equipment entering the energy-saving mode may include: obtaining the target value range where the expected value of the user equipment for the network configuration parameter is located, wherein the number of the target value ranges may be the same as the number of the network configuration parameters: determining the energy-saving demand level corresponding to or matching with each target value range: and determining, according to the energy-saving demand level matching with each target value range, the energy-saving demand level of the user equipment entering the energy-saving mode.

In some embodiments, the operation of determining, according to the energy-saving demand level matching with each target value range, the energy-saving demand level of the user equipment entering the energy-saving mode may include, but not be limited to, the following approaches including an approach 1 and an approach 2.

The approach 1: in a case where the energy-saving demand level matching with each target value range includes a highest energy-saving demand level, determining that the energy-saving demand level of the user equipment entering the energy-saving mode may be the highest energy-saving demand level: in a case where the energy-saving demand level matching with each target value range does not include the highest energy-saving demand level, determining that the energy-saving demand level of the user equipment entering the energy-saving mode may be the highest one of the energy-saving demand levels of the energy-saving demand levels matching with various target value range. In some embodiments, in a case where the energy-saving demand level matching with each target value range does not include the highest energy-saving demand level, obtaining the number of the target value ranges whose matched or corresponding energy-saving demand levels are not the lowest energy-saving demand level, and determining the energy-saving demand level of the user equipment entering the energy-saving mode as the energy-saving demand level matching with this number.

The lowest energy-saving demand level may mean that the user equipment does not need to enter the energy-saving mode. The more the number of the target value ranges whose matched energy-saving demand levels are not the lowest energy-saving demand level, the higher the energy-saving demand level of the user equipment entering the energy-saving mode.

In some embodiments of the present disclosure, the network configuration parameter may include at least one selected from the group consisting of: the DRX parameter, the maximum aggregated bandwidth, the maximum number of carrier waves, the maximum number of MIMO layers, the minimum scheduling offset value for cross-slot scheduling, and the Radio Resource Control (RRC) state. The greater the value in each value range matching with the DRX parameter is, the higher the matched energy-saving demand level is. The less the value in each value range matching with the maximum aggregate bandwidth, the higher the matched energy-saving demand level is. The less the value in each value range matching with the maximum number of carrier waves, the higher the matched energy-saving demand level is. The less the value in each value range matching with the maximum number of MIMO layers, the higher the matched energy-saving demand level is. The less the value in each value range matching with the minimum scheduling offset value for cross-slot scheduling, the higher the matched energy-saving demand level is. The various value ranges matching with the RRC state may include a value range 1 and a value range 2. The value range 1 may indicate that the RRC state is the idle state. The value range 2 may indicate that the RRC state is a connected state. The energy-saving demand level matching with the value range 1 may be the highest. The energy-saving demand level matching with the value range 2 may be the next-highest or second-highest. Accordingly, a situation where the energy-saving demand level matching with each target value range includes the highest energy-saving demand level may include at least one situation selected from the group consisting of: the expected value of the DRX parameter reaching a maximum value specified in the protocol: the expected value of the maximum aggregated bandwidth reaching the minimum value specified in the protocol: the expected value of the maximum number of carrier waves reaching the minimum value 0 specified in the protocol: the expected value of the maximum number of MIMO layers reaching the minimum value I specified in the protocol: the expected value of the minimum scheduling offset value for cross-slot scheduling reaching the maximum value specified in the protocol: or the expected value of the RRC state being within the value range 1.

The approach 2: obtaining the number of the target value ranges whose matched energy-saving demand levels are not the lowest energy-saving demand level. In a case where the above-mentioned number is less than a number threshold, determining that the energy-saving demand level of the user equipment entering the energy-saving mode may be the energy-saving demand level matching with the above-mentioned number. In a case where the above-mentioned number is greater than or equal to the number threshold, determining whether at least one highest energy-saving demand level is included in the matched various energy-saving demand levels. If at least one highest energy-saving demand level is included, determining that the energy-saving demand level of the user equipment entering the energy-saving mode is the highest energy-saving demand level.

In a case where the above-mentioned number is greater than or equal to the number threshold, and the highest energy-saving demand level is not included in the matched various energy-saving demand levels, determining the energy-saving demand level of the user equipment entering the energy-saving mode as the energy-saving demand level matching with the above-mentioned number. As an example, the above-mentioned number threshold may be 2.

The operation at block 303: determining, according to the energy-saving demand level of the user equipment entering the energy-saving mode, the first target number of the HARQ processes configured for the user equipment.

In some embodiments, the operation of determining, according to the energy-saving demand level of the user equipment entering the energy-saving mode, the first target number of the HARQ processes configured for the user equipment may include: determining the HARQ process number matching with the energy-saving demand level of the user equipment entering the energy-saving mode in a HARQ process number table as the first target number of the HARQ processes configured for the user equipment. The HARQ process number table may include: a plurality of energy-saving demand levels: and the HARQ process number matching each energy-saving demand level.

The energy-saving demand level may be inversely proportional to the HARQ process number. The higher the energy-saving demand level, the less the HARQ process number is matched.

As an example, the energy-saving demand levels may include a first level, a second level, a third level, and a fourth level. The first level may indicate that the user equipment does not need to enter the energy-saving mode. Each of the second level, the third level and the fourth level may indicate that, the user equipment may need enter the energy-saving mode. The corresponding energy-saving demand level may gradually increase from the second level to the fourth level.

As an example, when the energy-saving demand level of the user equipment entering the energy-saving mode is the second level, the first target number may be ½ of an original HARQ process number: when the energy-saving demand level of the user equipment entering the energy-saving mode is the third level, the first target number may be ¼ of the original HARQ process number: when the energy-saving demand level of the user equipment entering the energy-saving mode is the fourth level, the first target number may be 1.

The operation at block 304: issuing the first target number to the user equipment.

In some embodiments, the dedicated signaling may include the high-level signaling.

Further, the issuing the first target number to the user equipment may include: obtaining a target high-level signaling, wherein the target high-level signaling may include the first target number: and issuing the target high-level signaling to the user equipment.

In some embodiments, after the operation at block 303, second information reported by the user equipment may also be received, wherein the second information is configured to indicate that the user equipment needs to enter the energy-saving mode, the second target number may thus be issued to the user equipment. The second target number may be less than the first target number.

In some embodiments, the second information may include the auxiliary information of the user equipment. For the introduction of the auxiliary information, please refer to the above-mentioned description, which will not be elaborated herein.

In some embodiments, a second target number may be obtained by reducing the first target number according to a preset step size, or by reducing on the basis of the first target number according to a preset step size.

In a case where the first target number refers to the HARQ process number in the energy-saving mode, the second target number may be obtained by decrementing on the basis of the first target number, thereby further improving the energy-saving effect of the user equipment. In a case where the first target number refers to the HARQ process number in the normal mode, the second target number may refer to the number subject to a first reduction of the HARQ process number.

The second target number may be the number of the uplink scheduling HARQ processes and/or the downlink scheduling HARQ processes in the HARQ processes configured for the user equipment, the second target number may be reduced by the preset step size on the basis of the first target number. When receives the second information reported by the user equipment, the base station may reduce the uplink scheduling HARQ processes and/or the downlink scheduling HARQ processes in accordance with the preset step size on the basis of the first target number. As an example, the preset step size may be 2, 3, or the like.

In some embodiments, the second target number may be determined according to the second information. It should be noted that, regarding the determination approach for the second target number, one may refer to the determination approach for the first target number as mentioned above, which will not be elaborated herein.

Regarding the issuing approach of the second target number, one may refer to the issuing approach of the first target number, which will not be elaborated herein.

By implementing the above-mentioned method, the base station may identify, according to the first information reported by the user equipment, the energy-saving demand level at which the user equipment needs to enter the energy-saving mode, and determine the first target number of the HARQ processes configured for the user equipment according to this energy-saving demand level. In this way, the granularity of the HARQ process allocation may be further refined, making the allocation of the HARQ processes more flexible, so as to better meet the power consumption needs of the user equipment and facilitate reducing the power consumption waste of the user equipment.

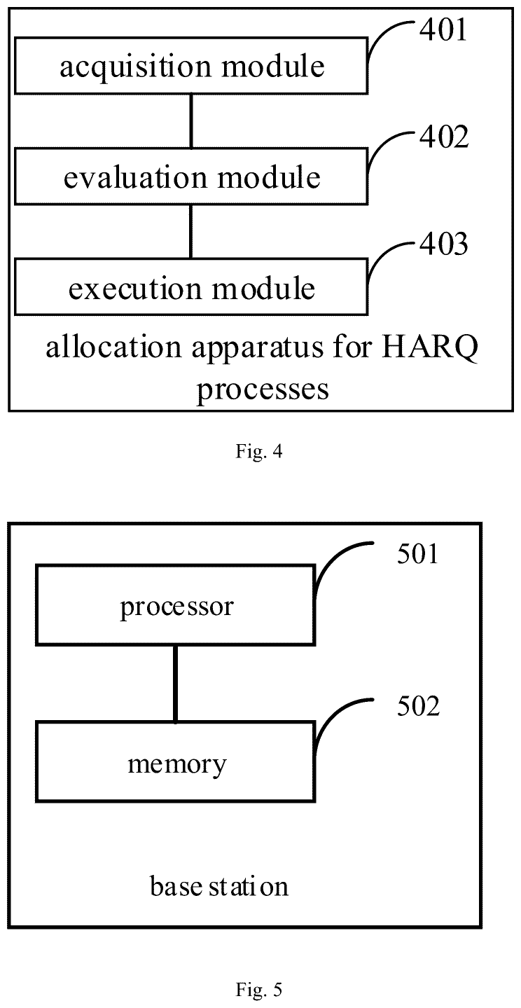

As illustrated in FIG. 4, FIG. 4 is a structural schematic diagram of an embodiment of a HARQ process allocation apparatus according to the present disclosure. As illustrated in FIG. 4, the allocation apparatus for HARQ processes may include an acquisition module 401, an evaluation module 402 and an execution module 403.

The acquisition module 401 may be configured to receive the first information reported by the user equipment. The first information may be configured to indicate whether the user equipment needs to enter the energy-saving mode. The operation modes of the user equipment may include the energy-saving mode and the normal mode. The power consumption of the user equipment in the energy-saving mode may be less than that of the user equipment in the normal mode.

The evaluation module 402 may be configured to determine, according to the first information, the first target number of the HARQ processes configured for the user equipment.

The execution module 403 may be configured to issue the first target number to the user equipment.

In some embodiments, a specific way for the evaluation module 402 to determine, according to the first information, the first target number of the HARQ processes configured for the user equipment may include: the evaluation module 402 may be configured to, in the case where the first information indicates that the user equipment does not need to enter the energy-saving mode, determine the first target number as the first value: and, in the case where the first information indicates that the user equipment needs to enter the energy-saving mode. determine the first target number as the second value. The second value may be less than the first value.

In some embodiments, the acquisition module 401 may be further configured to: after the execution module 403 issues the first target number to the user equipment, receive the second information reported by the user equipment. The second information may be configured to indicate that the user equipment needs to enter the energy-saving mode.

Additionally, the execution module 403 may further be configured to issue the second target number to the user equipment. The second target number may be less than the first target number.

In some embodiments, the second target number may be obtained by reducing on the basis of the first target number according to a preset step size. In some embodiments, the second target number may be obtained through reducing the first target number by the preset step size.

In some embodiments, the HARQ processes configured for the user equipment may include the uplink scheduling HARQ processes of the user equipment and/or the downlink scheduling HARQ processes of the user equipment.

The second target number may be the number of the uplink scheduling HARQ processes and/or the downlink scheduling HARQ processes in the HARQ processes configured for the user equipment. The second target number may be reduced on the basis of the first target number by the preset step size.

In some embodiments, the first information may be the auxiliary information of the user equipment. The auxiliary information may include the expected value of the user equipment for the network configuration parameter.

Further, in some embodiments, the specific ways for the evaluation module 402 to determine, according to the first information, the first target number of the HARQ processes configured for the user equipment may specifically include: the evaluation module 402 may be configured to determine, according to the target value range where the expected value of the user equipment for the network configuration parameter is located, the energy-saving demand level of the user equipment entering the energy-saving mode, and to determine, according to the energy-saving demand level of the user equipment entering the energy-saving mode, the first target number of the HARQ processes configured for the user equipment.

In some embodiments, the above-mentioned network configuration parameter may include the at least one selected from the group consisting of: the discontinuous reception DRX parameter, the maximum aggregated bandwidth, the maximum number of carrier waves, the maximum number of MIMO layers, the minimum scheduling offset value for the cross-slot scheduling, and the radio resource control (RRC) state.

In some embodiments, the specific way for the execution module 403 to issue the first target number to the user equipment may specifically include: the execution module 403 may be configured to obtain the target high-level signaling, wherein the target high-level signaling may include the first target number: and to issue the target high-level signaling to the user equipment.

As illustrated in FIG. 5, FIG. 5 is a structural schematic diagram of an embodiment of the base station according to the present disclosure. The base station as illustrated in FIG. 5 may include a processor 501 and a memory 502 coupled to the processor 501.

The processor 501 may include one or more processing cores. The processor 501 may be connected to various portions within the entire base station via a variety of interfaces and wiring, and may perform various functions of the base station and process data by running or executing instructions, programs, code sets, or instruction sets stored in the memory 502, as well as by calling up data stored in the memory 502.

The memory 502 may be a read-only memory (ROM, a static storage device, a dynamic storage device, or a random-access memory (RAM).

In some embodiments of the present disclosure, the processor 501 may further include the following functions: receiving the first information reported by the user equipment, wherein the first information may be configured to indicate whether the user equipment needs to enter the energy-saving mode, the operation modes of the user equipment may include the energy-saving mode and the normal mode, the power consumption of the user equipment in the energy-saving mode may be less than that of the user equipment in the normal mode: determining, according to the first information, the first target number of the HARQ processes configured for the user equipment: and issuing the first target number to the user equipment.

In some embodiments of the present disclosure, the processor 501 may further include the following functions: in the case where the first information indicates that the user equipment does not need to enter the energy-saving mode, determining the first target number as the first value: in the case where the first information indicates that the user equipment needs to enter the energy-saving mode, determining the first target number as the second value. The second value may be less than the first value.

In some embodiments of the present disclosure, the processor 501 may further include the following functions: receiving the second information reported by the user equipment, wherein the second information may be configured to indicate that the user equipment needs to enter the energy-saving mode: issuing the second target number to the user equipment, wherein the second target number may be less than the first target number.

In some embodiments of the present disclosure, the second target number may be obtained by reducing on the basis of the first target number according to the preset step size.

In some embodiments of the present disclosure, the HARQ processes configured for the user equipment may include the uplink scheduling HARQ processes of the user equipment and/or the downlink scheduling HARQ processes of the user equipment.

The second target number may be the number of the uplink scheduling HARQ processes and/or the downlink scheduling HARQ processes in the HARQ processes configured for the user equipment. The second target number may be reduced by the preset step size on the basis of the first target number.

In some embodiments of the present disclosure, the first information may be the auxiliary information of the user equipment. The auxiliary information may include the expected value of the user equipment for the network configuration parameter. In some embodiments of the present disclosure, the processor 501 may further include the following functions: determining, according to the target value range where the expected value of the user equipment for the network configuration parameter is located, the energy-saving demand level of the user equipment entering the energy-saving mode: and determining, according to the energy-saving demand level of the user equipment entering the energy-saving mode, the first target number of the HARQ processes configured for the user equipment.

In some embodiments of the present disclosure, the network configuration parameter may include at least one selected from the group consisting of: the discontinuous reception DRX parameter, the maximum aggregated bandwidth, the maximum number of carrier waves, the maximum number of MIMO layers, the minimum scheduling offset value for the cross-slot scheduling. and the radio resource control (RRC) state.

In some embodiments of the present disclosure. the processor 501 may further include the following functions: obtaining the target high-level signaling. wherein the target high-level signaling may include the first target number: issuing the target high-level signaling to the user equipment.

In various embodiments of the present application. the order of the sequence numbers of the various processes described above does not imply the sequence of execution. and the sequence of execution of the processes should be determined by their function and inherent logic, and should not constitute any limitation on the processes implemented in the embodiments of the present application.

Those of ordinary skills in the art may realize that. the units and algorithmic steps of the various examples described in conjunction with the embodiments disclosed herein may be capable of being implemented in electronic hardware, or a combination of computer software and electronic hardware. Whether these functions are performed in hardware or software depends on the specific application and design constraints of the technical schemes. For each particular application. a person skilled in the art may use different methods to implement the described functions, but such implementations should not be considered as beyond the scope of the present disclosure.

It should be clear to those skilled in the art to which the present disclosure belongs that, for the sake of convenience and brevity, the specific operating processes of the above-described systems, apparatuses, and units may be referred to the corresponding processes in the foregoing method embodiments, and will not be elaborated herein.

In the embodiments provided in the present disclosure, the disclosed system, apparatus and method may be embodied in other ways. For example, the apparatus embodiment described above may merely be illustrative. For example, the division of the units may only be a logical function division, and there may be other division manners in actual implementations. For example, a plurality of units or components may be combined or integrated into another system. Or some features may be ignored or not implemented. In addition, the illustrated or discussed mutual coupling or direct coupling or communicating connection may be indirect coupling or communicating connection through some interfaces, apparatuses or units, and may be electrical, mechanical or other forms.

The units illustrated as separate components may or may not be physically separate, and the components illustrated as units may or may not be physical units. The units may be located in one place or may be distributed on multiple network units. Some or all of the units may be selected as per actual needs to fulfill the object of the implementation of the present embodiment.

In addition, each functional unit in embodiments of the present disclosure may be integrated into one processing unit, or may be physically separate units, or two or more units may be integrated into one unit.

If the function is implemented in the form of software functional units and sold or used as independent product, then they could be stored in a computer-readable storage medium. Based on such kind of appreciation, the technical solutions of the present disclosure may essentially be or a part of the same that contributes to the related art or part of the technical solution may be embodied in the form of software products. The computer software products may be stored in one storage medium. The computer software product may include several instructions which may enable a computer device (which may be a personal computer, a server, or a network device etc.) to implement all or a part of the operations of the method according to various embodiments of the present disclosure. The afore-mentioned storage medium may include: a U disk, a mobile hard disk drive, a read only memory (ROM), a random-access memory (RAM), a magnetic disk or a CD-ROM and other medium that may store program codes.

In some embodiments, a computer program product may be provided. When being executed on a computer, this computer program product may enable the computer to implement any embodiment of the HARQ process allocation method as mentioned above.

In some embodiments, an application publishing platform may be provided. The application publishing platform is configured to publish a computer program product. When being executed on a computer, the computer program product may enable the computer to implement any embodiment of the HARQ process allocation method as mentioned above.

The above may only be specific implementations of the present disclosure, and the protection scope of the present disclosure may not be limited thereto. Changes or alternations within the technical scope of the present disclosure may easily occur to those skilled in the art and should be considered to be in the protection scope of the present disclosure. Therefore, the protection scope of the present disclosure should be subject to the appended claims.

1. A hybrid automatic repeat request (HARQ) process allocation method, comprising:
receiving first information reported by user equipment, wherein the first information is configured to indicate whether the user equipment needs to enter an energy-saving mode, operation modes of the user equipment comprise the energy-saving mode and a normal mode, a power consumption of the user equipment in the energy-saving mode is less than that of the user equipment in the normal mode:
determining, according to the first information, a first target number of HARQ processes configured for the user equipment: and
issuing the first target number to the user equipment.

2. The method as claimed in claim 1, wherein
the determining, according to the first information, the first target number of the HARQ processes configured for the user equipment comprises:
in a case where the first information indicates that the user equipment does not need to enter the energy-saving mode, determining the first target number as a first value:
in a case where the first information indicates that the user equipment needs to enter the energy-saving mode, determining the first target number as a second value:
wherein the second value is less than the first value.

3. The method as claimed in claim 1, wherein
after the issuing the first target number to the user equipment, the method further comprises:
receiving second information reported by the user equipment, wherein the second information is configured to indicate whether the user equipment needs to enter the energy-saving mode:
issuing a second target number to the user equipment, wherein the second target number is less than the first target number.

4. The method as claimed in claim 3, wherein
the second target number is obtained by reducing the first target number by a preset step size.

5. The method as claimed in claim 4, wherein
the HARQ processes configured for the user equipment comprise uplink scheduling HARQ processes of the user equipment and/or downlink scheduling HARQ processes of the user equipment:
wherein the second target number is the number of the uplink scheduling HARQ processes and/or the downlink scheduling HARQ processes in the HARQ processes configured for the user equipment, the second target number is obtained through reducing the first target number by the preset step size.

6. The method as claimed in claim 5, wherein
the HARQ processes configured for the user equipment comprise the uplink scheduling HARQ processes of the user equipment, the method further comprises:
configuring a default number of downlink scheduling HARQ processes for the user equipment.

7. The method as claimed in claim 1, wherein
the first information is auxiliary information of the user equipment, the auxiliary information comprises an expected value of the user equipment for a network configuration parameter:
wherein the determining, according to the first information, the first target number of the HARQ processes configured for the user equipment comprises:
determining, according to a target value range where the expected value of the user equipment for the network configuration parameter is located, an energy-saving demand level of the user equipment entering the energy-saving mode:
determining, according to the energy-saving demand level, the first target number of the HARQ processes configured for the user equipment.

8. The method as claimed in claim 7, wherein
the determining, according to the target value range where the expected value of the user equipment for the network configuration parameter is located, the energy-saving demand level of the user equipment entering the energy-saving mode comprises:
obtaining the target value range where the expected value of the user equipment for the network configuration parameter is located, wherein the number of target value ranges is the same as the number of network configuration parameters:
determining the energy-saving demand level matching with each target value range:
determining, according to the energy-saving demand level matching with each target value range, the energy-saving demand level of the user equipment entering the energy-saving mode.

9. The method as claimed in claim 7, wherein
the network configuration parameter comprises at least one selected from the group consisting of: a discontinuous reception (DRX) parameter, a maximum aggregated bandwidth, a maximum number of carrier waves, a maximum number of multiple-input multiple-output (MIMO) layers, a minimum scheduling offset value for cross-slot scheduling, and a radio resource control (RRC) state.

10. The method as claimed in claim 1, wherein
the issuing the first target number to the user equipment comprises:
issuing the first target number to the user equipment through a dedicated signaling or a particular system message.

11. The method as claimed in claim 10, wherein
the dedicated signaling comprises any one selected from the group consisting of: a high-level signaling, a layer one signaling and a layer two signaling.

12. The method as claimed in claim 11, wherein
the high-level signaling comprises an RRC signaling.

13. The method as claimed in claim 12, wherein
after the issuing the first target number to the user equipment through the RRC signaling, the method further comprises:
receiving response information fed back by the user equipment:
determining whether the first target number is successfully sent by analyzing the response information.

14. The method as claimed in claim 1, wherein
the issuing the first target number to the user equipment comprises:
obtaining a target high-level signaling, wherein the target high-level signaling comprises the first target number:
issuing the target high-level signaling to the user equipment.

15. A base station, comprising:
a memory, storing an executable program code: and
a processor, coupled to the memory:
wherein the processor is configured to call the executable program code stored in the memory:
the executable program code, when being executed by the processor, is configured to enable the processor to implement a HARQ process allocation method,
wherein the HARQ process allocation method comprises:
receiving first information reported by user equipment, wherein the first information is configured to indicate whether the user equipment needs to enter an energy-saving mode, operation modes of the user equipment comprise the energy-saving mode and a normal mode, a power consumption of the user equipment in the energy-saving mode is less than that of the user equipment in the normal mode:
determining, according to the first information, a first target number of HARQ processes configured for the user equipment: and
issuing the first target number to the user equipment.

16. The base station as claimed in claim 15, wherein
the determining, according to the first information, the first target number of the HARQ processes configured for the user equipment comprises:
in a case where the first information indicates that the user equipment does not need to enter the energy-saving mode, determining the first target number as a first value:
in a case where the first information indicates that the user equipment needs to enter the energy-saving mode, determining the first target number as a second value:
wherein the second value is less than the first value.

17. The base station as claimed in claim 15, wherein
after the issuing the first target number to the user equipment, the method further comprises:
receiving second information reported by the user equipment, wherein the second information is configured to indicate whether the user equipment needs to enter the energy-saving mode:
issuing a second target number to the user equipment, wherein the second target number is less than the first target number.

18. A non-transitory computer-readable storage medium storing a computer program, wherein
the computer program, when being executed by a processor, is configured to enable the processor to implement a HARQ process allocation method, the method comprises:
receiving first information reported by user equipment, wherein the first information is configured to indicate whether the user equipment needs to enter an energy-saving mode, operation modes of the user equipment comprise the energy-saving mode and a normal mode, a power consumption of the user equipment in the energy-saving mode is less than that of the user equipment in the normal mode:
determining, according to the first information, a first target number of HARQ processes configured for the user equipment; and
issuing the first target number to the user equipment.

19. The non-transitory computer-readable storage medium as claimed in claim 18, wherein
the determining, according to the first information, the first target number of the HARQ processes configured for the user equipment comprises:
in a case where the first information indicates that the user equipment does not need to enter the energy-saving mode, determining the first target number as a first value;
in a case where the first information indicates that the user equipment needs to enter the energy-saving mode, determining the first target number as a second value;
wherein the second value is less than the first value.

20. The non-transitory computer-readable storage medium as claimed in claim 18, wherein
after the issuing the first target number to the user equipment, the method further comprises:
receiving second information reported by the user equipment, wherein the second information is configured to indicate whether the user equipment needs to enter the energy-saving mode;
issuing a second target number to the user equipment, wherein the second target number is less than the first target number.
